(19) United States
(12) Patent Application Publication
(10) Pub. No.: US 2013/0263151 A1
(43) Pub. Date: Oct. 3, 2013

(54) Consistent Hashing Table for Workload Distribution

(71) Applicants: Jin Li, Bellevue, WA (US); Cheng Huang, Redmond, WA (US); Sudipta Sengupta, Redmond, WA (US); Christopher Broder Wilson, Santa Barbara, CA (US)

(72) Inventors: Jin Li, Bellevue, WA (US); Cheng Huang, Redmond, WA (US); Sudipta Sengupta, Redmond, WA (US); Christopher Broder Wilson, Santa Barbara, CA (US)

(73) Assignee: MICROSOFT CORPORATION, Redmond, WA (US)

(21) Appl. No.: 13/438,465

(22) Filed: Apr. 3, 2012

(51) Int. Cl. G06F 9/46

(52) U.S. Cl. 718/105

(57) ABSTRACT

Described is a technology by which a consistent hashing table of bins maintains values representing nodes of a distributed system. An assignment stage uses a consistent hashing function and a selection algorithm to assign values that represent the nodes to the bins. In an independent mapping stage, a mapping mechanism deterministically maps an object identifier/key to one of the bins as a mapped-to bin.

### BACKGROUND

Consistent hashing is a mechanism used to dynamically distribute workload (such as computing processes, blob storage, which can be generalized as objects having IDs) across multiple nodes of a distributed system, which may be a node cluster. Contemporary consistent hashing is performed via a consistent hashing ring, in which the output range of a hash function is treated as a fixed circular space (i.e., a “ring”), with the largest hash value wrapping around to the smallest hash value. Each node in the system is assigned an ID value within this space which represents its identity on the ring. Each object, which can be a computing process, a key-value blob, or other entity, is also assigned an object ID in the same space. To assign the object to a node, the object is assigned to the node whose ID is immediately before or after the object's ID.

The consistent hashing ring thus provides a mechanism to distribute a large collection of objects to nodes. Because the distribution is deterministic once the object ID is known, the consistent hashing ring provides a mechanism to assign objects to nodes in a deterministic fashion.

While this mechanism works to an extent, in a dynamic environment, a new node may join, or an existing node may leave. In consistent hashing, this means the ID of a node is inserted or deleted from the ring, respectively. Adding a new node may cause a significant shift of the workload, as a newly inserted node may take a significant portion of the workload from its neighbor. Conversely, when a node leaves, that node may transfer all of its workload to its neighbor. Such significant workload shifts are undesirable and can lead to unbalanced workloads.

Other problems with the consistent hashing ring exist. For example, if the ID of the node is randomly assigned, which is frequently the case for the purpose of distributing the workload uniformly in a large cluster, the space between the two nodes may not be uniform, which causes some nodes to take more load than others. Further, if a node has more resources than another node, for example, the node with more resources does not necessarily get more of the load.

One existing solution creates multiple virtual IDs for each node, with the number of virtual IDs for a given node proportional to that node's resources (e.g., CPU capacity for computation workload, storage capacity for blob storage). To assign object to a node, the object is assigned to the node whose virtual ID is immediately before (or after). In such a ring, if a node leaves, its workload is divided to portion associated with its virtual IDs, with each portion reallocated to one another node in the cluster. If a node joins, it attempts to insert multiple virtual IDs (depending on its resources) into the system, each of which takes a portion of the workload from its other neighbors. However, with this system, a distributed routing protocol is needed to reach the node which holds the relevant information, and locate the node to which the object is assigned, which makes the solution complex. Alternatively, if the information of the system is known to participants, the consistent hashing ring can be implemented via a sorted B-tree, however this is also highly complex with respect to memory complexity, search complexity and computational complexity, particularly when a node joins or leaves the system.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a data structure (a consistent hashing table) configured with bins maintains values representing nodes of a distributed system. In an assignment stage, an assignment mechanism comprising a consistent hashing function assigns values that represent the nodes to the bins using a consistent selection algorithm. In a mapping stage, a mapping mechanism deterministically maps an object identifier/key to one of the bins as a mapped-to bin, to obtain the node set (one or more nodes) that corresponds to the value or values of the mapped-to bin.

In one aspect, each bin may contain a plurality of values in cells of the bin, to allow a node set of a corresponding number of nodes to be represented in that bin. An object may thus be associated with a plurality of nodes.

In one aspect, each bin may contain values in alternate cells. If a node leaves the distributed system, a value from an alternate cell may be used as a replacement, to avoid having to repopulate the data structure by re-running another assignment stage.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components in a distributed system that assigns node values to bins a consistent hashing table, and maps an object identifier to one of the bins to determine the node or nodes associated with that object.

FIG. 2 is a representation of a consistent hashing table with single-cell bins containing node values selected by an assignment function and mapped to by a mapping function.

FIG. 3 is a representation of a consistent hashing table with multiple-cell (multi-cell) bins containing node values selected by an assignment function and mapped to by a mapping function.

FIG. 4 is a representation of how node values in alternate cells may be used to replace node values that represent a node that is leaving the distributed system.

FIG. 5 is a block diagram representing example non-limiting networked environments in which various embodiments described herein can be implemented.

FIG. 6 is a block diagram representing an example non-limiting computing system or operating environment in which one or more aspects of various embodiments described herein can be implemented.

### DETAILED DESCRIPTION

Various aspects of the technology described herein are generally directed towards distributing objects or workloads in a distributed environment having multiple nodes, in which the distribution is based upon the identity and the capacity of each individual node for handling workloads. To this end, a consistent hashing table is provided for workload distribution. As will be understood, the consistent hashing table comprises two independent stages, namely a mapping stage and a selective (assignment) stage. In general, the mapping stage maps multiple objects/workloads into a bin. The selective stage assigns each bin to one or more nodes deterministically, based upon the IDs of the nodes. The mapping function serves the purpose of dividing the workloads into multiple assignment units, each of which has a unique assignment schedule in the distributed cluster. The assignment stage creates one specific assignment outcome for each assignment unit, and allows the assignment of multiple nodes to each assignment unit (the number of nodes of the assignment can vary among assignment units). With an appropriate implemented mapping function and assignment function, a consistent hashing table implementation may deterministically distribute objects/workloads among a node cluster, with the result of the distribution only dependent upon the ID of the node and the capacity of the node. Whenever one or more nodes join or leave the node cluster, only a small portion of the workload (proportional to the capacity of the joining or leaving node or nodes) is redistributed to other nodes in the cluster. Further, the redistribution of the workload resultant from the node joining/leaving is generally evenly redistributed among the rest of the nodes in the cluster, so that no particular node is overwhelmed or otherwise significantly affected by the joining/leaving situation.

As will be understood, the consistent hashing table technology described herein is capable of dealing with randomly distributed objects, objects distributed in a range space, or objects distributed in cluster space (in which close-by objects are desired to be assigned to the same node, which can be implemented through a mapping function that maps close-by objects to the same bin). The consistent hashing table may be implemented with low memory and computational complexity.

It should be understood that any of the examples herein are non-limiting. For instance, example mapping and assignment functions are described herein for purposes of explanation, however alternative mapping and/or assignment functions may be used. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in distributed computing in general.

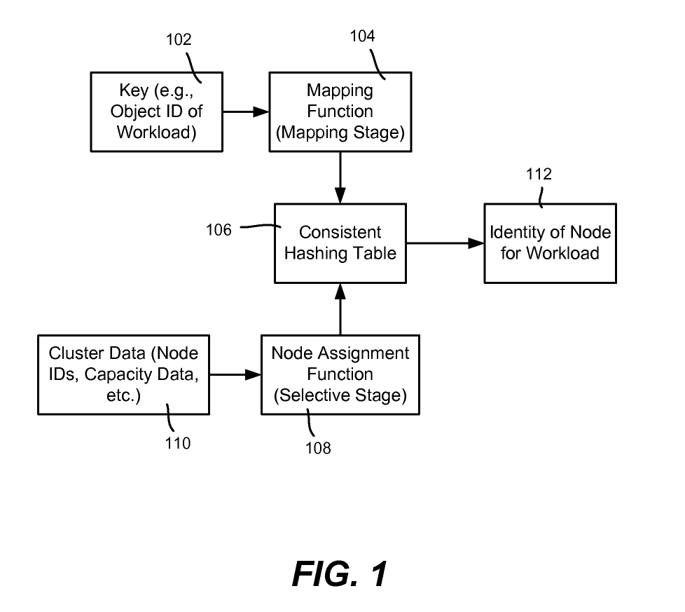

FIG. 1 shows a block diagram illustrating general concepts of an example workload distribution mechanism based upon the use of a consistent hashing table. As used herein, “workload” and “object” are interchangeable, and each has an identifier (ID) that is unique among the various workloads/objects of the distributed system. As represented in FIG. 1, the ID acts as a key 102 to a mapping mechanism comprising a mapping function 104 that maps the key 102 based upon its value to a bin in the consistent hashing table 106. Example workload/object identifiers may be a URL, a GUID, a key of a (key, value) pair, and so on.

As represented in FIG. 1, to distribute workload using the consistent hashing table 106, the distribution operation is separated into two independent stages, namely the mapping stage, which uses the mapping function 104 to map objects to distribution bins, and a selective stage, which uses an assignment mechanism comprising an assignment function 108 to select one or more nodes for load distribution within each distribution bin. As will be understood, the assignment function 108 need be used only when the consistent hashing table needs to be initially populated, or repopulated such as due to a change in node membership as nodes join or leave the cluster/distributed system. The node assignment function 108 is based upon cluster data 110, including the available nodes of the system, the capacity of each, and the number of bins in use, as described below.

Once the table 106 is populated, in normal workload distribution operation, the node set (node or nodes) identity 112 for any given object is obtained by using the mapping function 104 to determine the bin, and looking up the node set associated with that bin. The output of the mapping function 104, comprising the value of the bin in the consistent hashing table 106, is thus based upon the ID value of the object as input. Thus, a characteristic of consistent hashing table technology is that the mapping stage and the selective stage are independent, in that the mapping stage maps the objects/workloads to a fixed set of bins regardless of the dynamic nature of the node clusters (e.g., there is no change in bin mapping when a node enters or leaves the cluster). The selective stage assigns one or more nodes deterministically to each bin, and operates regardless of how many bins are desired for use in the system. That is, the mapping function serves the purpose of dividing the workloads into multiple assignment units, each of which has a unique assignment schedule in the distributed cluster. The assignment stage creates one specific assignment outcome for each assignment unit, and allows the assignment of multiple nodes to each assignment unit (the number of nodes of the assignment can vary among assignment units).

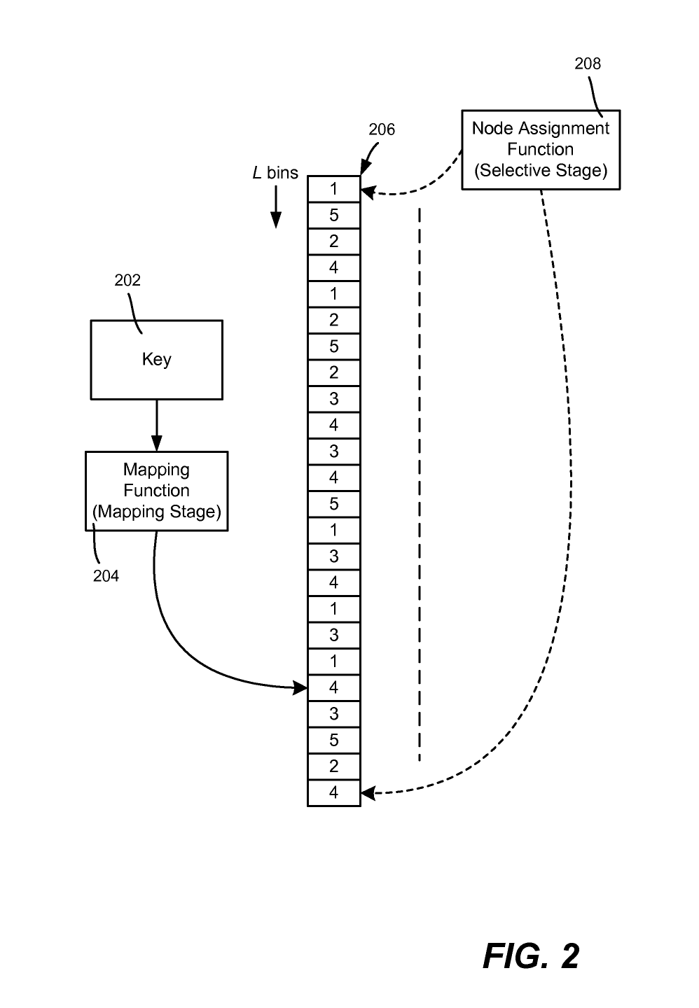

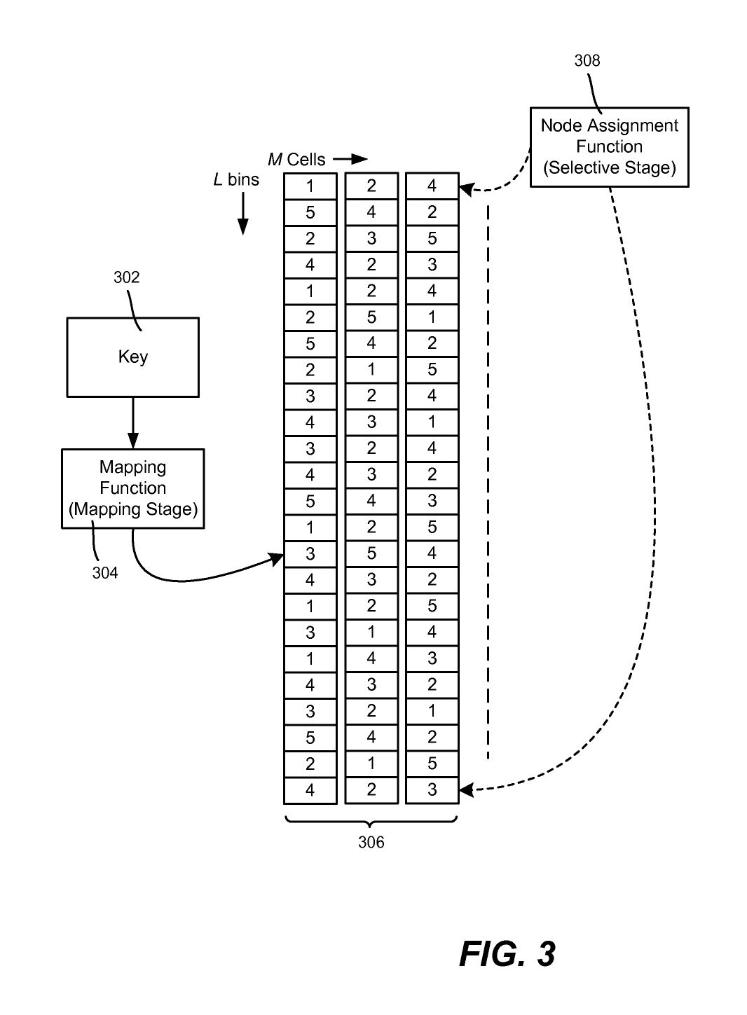

As represented in FIG. 2, which illustrates an example consistent hashing table 206 with a mapping function 204 and an assignment function 208 for single cell bins, in the mapping stage, an object key 202 is mapped to one of L bins (e.g., numbered 0 to L−1) through a mapping function 204 map(o). Each bin is assigned to one node in the single cell implementation, or a set of nodes in a multiple cell implementation (described below with reference to FIG. 3). Example node numbers representing the assignments are exemplified as simple integers one through five in the bins' cells.

The mapping function 204 can be implemented in a number of ways, including through a hashing function, which serves to generally evenly distribute randomly-valued incoming object keys, e.g.,:

map(o)=hash(o)mod L.

An alternative mapping function implements range binning, if the object can be sorted. That is, suppose the object o can be sorted, a set of range boundaries, r₀, r₁, . . . , r_{L}, with rₒ=min{o}, r_{L}=max{o} are established. A suitable range-binning mapping function is:

map(o)=j, if rⱼ≦o<rⱼ₊₁.

A third mapping function corresponds to a clustering algorithm. That is, if the distance of two objects dist(oᵢ,oⱼ) can be measured, a set of clusters with centroid {c₁, . . . , c_{L}} may be established, e.g.,:

map(o)=j, if dist(o,cᵢ)<dist(o,cₖ),∀j≠k.

Note that unlike other workload distribution algorithms such as a consistent hashing ring, the consistent hashing table technology allows the use of range space or cluster space to bin the objects. Further, note that any of the above mapping functions map the objects/workloads to a fixed set of bins regardless of the dynamic state of the nodes in the node cluster/distributed system. That is, nodes may dynamically enter and/or leave a cluster/distributed system, however the number of bins in the mapping stage are not affected by the dynamic nature of the nodes.

In an extreme implementation, it is feasible for the mapping function to map each individual object to a separate bin, with the ID of the bin simply being the ID of the object. Such an implementation is feasible if the number of objects is small. However, if the number of objects is large, the computation may not be efficient because in the consistent hash table, whenever a node enters the distributed system, each bin needs to be reevaluated to see if the newly entering node will be assigned to the bin, and whenever a node leaves the distributed system, each bin that maps to the leaving node will need to compute for an alternative assignment. Thus, the computation complexity associated with node entering and leaving the distributed system is closely associated with the number of bins in the system.

In the selection stage, for each bin, an assignment function 208 is used to select one node (or a set of nodes in FIG. 3) to which each bin is assigned. As set forth above, this is independent of the mapping, and may depend only on the ID of each node (represented by Nᵢ for i nodes), capacity Cᵢ of each node, and the number of bins to assign, e.g., Aⱼ=f(j, N₁, . . . , Nₖ, C₁, . . . , Cₖ)ε{0, . . . , L−1}. In general, for L bins to assign, the selection stage runs L independent assignment functions, each of which deterministically but uniformly select one or multiple nodes for the assignment unit. A suitable assignment function includes the property that the probability of the node being selected for assignment being proportional to the capacity of the node. This achieves the purpose that it allocates the number of bins assigned to a certain node Nᵢ in proportion to the capacity of the node Cᵢ, that is, the number of bins assigned to a node Nᵢ is generally close to Lᵢ=Cᵢ/Σ{Cᵢ}·L. Note that capacity may be predetermined in any suitable way, but for purposes of simplicity herein is represented as an integer greater than or equal to one with a linear relationship between values, e.g., a node with capacity of three (3) is capable of handling three times the workloads of a node with a capacity of one (1).

As another desirable property, whenever a node or multiple nodes enter or leave the node cluster, only a small portion of the bins (proportional to the capacity of the nodes joining or leaving) are affected. Another such desirable property is that whenever a node or multiple nodes enter or leave the node cluster, its workload (the bins that assigned to the node) are evenly redistributed among the node cluster as possible.

One implementation of such an assignment function is as follows, in which C represents capacity, and i represents the number of nodes. For each bin represented by its bin ID id_j, the assignment function calculates a total of Σ{Cᵢ} hash values, with Cᵢ values for node Nᵢ:

V_{j,i,k}=hash(id_{—}j,Nᵢ,k), with k=0, . . . , Cᵢ−1

By way of a simple example, if there are five nodes with a capacity that sums to ten, ten hash values are computed corresponding to assignment candidates from which to select, such that, for example, a node having a capacity that is three times the capacity of another node is thus three times as likely to be selected. In one implementation, the node that holds the largest hash value is selected as the node to which the bin j is assigned. Note that an alternative implementation is to select the node to be the one that corresponds to the smallest hash value, or the node that corresponds to the hash value close to a certain selected constant c. The selective function thus forms a deterministic order among the Σ{Cᵢ} hash values, and is capable of selecting one using a consistent selection algorithm (e.g., based on largest/smallest/closest value). For purposes of simplicity herein, the largest hash value will be used in the examples of selection/assignment.

The functionality of the consistent hashing table technology thus deterministically distributes objects to one or more nodes among the node cluster, with the result of the distribution only dependent upon the ID of the node and the capacity of the node. Whenever one or more nodes leave the node cluster, a small portion of the workload (the bins assigned to that node) are redistributed to other nodes in the clusters. Unlike the consistent hashing ring which may lead to a biased assignment if the objects are clustered on some portion of the ring, the consistent hashing table technology relies on a mapping function to generate a sufficient large number of bins for assignment, and relies on a selective function to assign bin to node with a probability proportional to the capacity of the node.

Note further that with a consistent hashing ring, there is no effective mechanism to assign two objects that are close to one node, as the hash value of the object can be very different on the ring. The consistent hashing table solves this problem by separating the mapping stage from the assignment stage. The functionality of the mapping stage clusters objects into multiple bins which may employ algorithms (e.g., via range clustering or centroid clustering described above) to group objects into bins and/or to favor objects that are close in distance. Other algorithms for other desired mapping may be employed.

Each bin thus serves as the unit element of workload distribution. If a certain bin contains too many objects, which may cause uneven workload assignment or uneven workload shift during node joining and/or leaving, such a bin may be further split into multiple bins (with its own bin ID) to equalize the workload. The mapping stage enables the consistent hashing table technology to intelligently cluster objects according to certain desired property.

Still further, a consistent hashing table may be implemented with low memory and computational complexity, e.g., relative to consistent hashing ring-based solutions. In one implementation the consistent hashing table comprises a table structure, with L memory cells; the workload distribution operation can be completed in O(1) complexity, as it is a straightforward table lookup operation.

Turning to another aspect, for certain workloads, multiple nodes need to be assigned to a single object (key). As one example, a paxos protocol may need to assign n nodes to run a distributed consensus algorithm. As a second example, generally represented in FIG. 3, for a distributed storage system with three replicas, the assignment function 308 needs to assign three nodes to each object. As another example, a distributed storage system with erasure coding needs a larger number of nodes assigned to each object, e.g., (6,3) Reed-Solomon code needs to assign nine nodes to each object, while a (14, 2, 2) local reconstruction code needs to assign eighteen nodes to each object.

The consistent hashing table technology meets the needed assignment by selecting multiple nodes in the assignment stage. Each assignment bin contains a plurality of cells (with each cell recording the assignment outcome of one node) to meet the number of nodes to which an object needs to be assigned. In the example of FIG. 3, which shows a multi-cell assignment function 308, the number of cells per bin is three.

One suitable multiple cell assignment function, where M is the number of cells per bin, may be implemented as follows. For each bin, the assignment function calculates a total of Σ{Cᵢ} hash values, with Cᵢ values for node Nᵢ:

V_{j,i,k}=hash(id_{—}j,Nᵢ,k), with k=0, . . . , Cᵢ−1

The resultant hash values are sorted, and the node that holds the largest hash value is selected in the first cell of bin j. Note that as with the single cell function, the number of hash values for each node depends on that node's capacity. Among the rest of the nodes, i.e., those not selected for the first cell (so that no bin has the same node selected more than once among its cells), the node that holds the largest hash value is selected as the second cell of bin j, and so on. That is, the selection is iterated until the Mth cell has been filled.

The workload distribution operation for a multi-cell consistent hashing table can be completed in O(1) complexity. The memory needed to complete the workload distribution is ML cells. To build a consistent hashing table from scratch, the computational complexity is O(L·M·(Σ{Cᵢ})) for a M-cell consistent hashing table, or O(L·log(Σ{Cᵢ})·(Σ{Cᵢ})), if M>log(Σ{Cᵢ}).

Whenever a node of capacity Cᵢ joins the consistent hashing table, the system reevaluates its L bins to determine whether some of the bins are to be reassigned to the arriving node. The computation complexity is L for a single-cell consistent hashing table, and L·log(M) for an M-cell consistent hashing table.

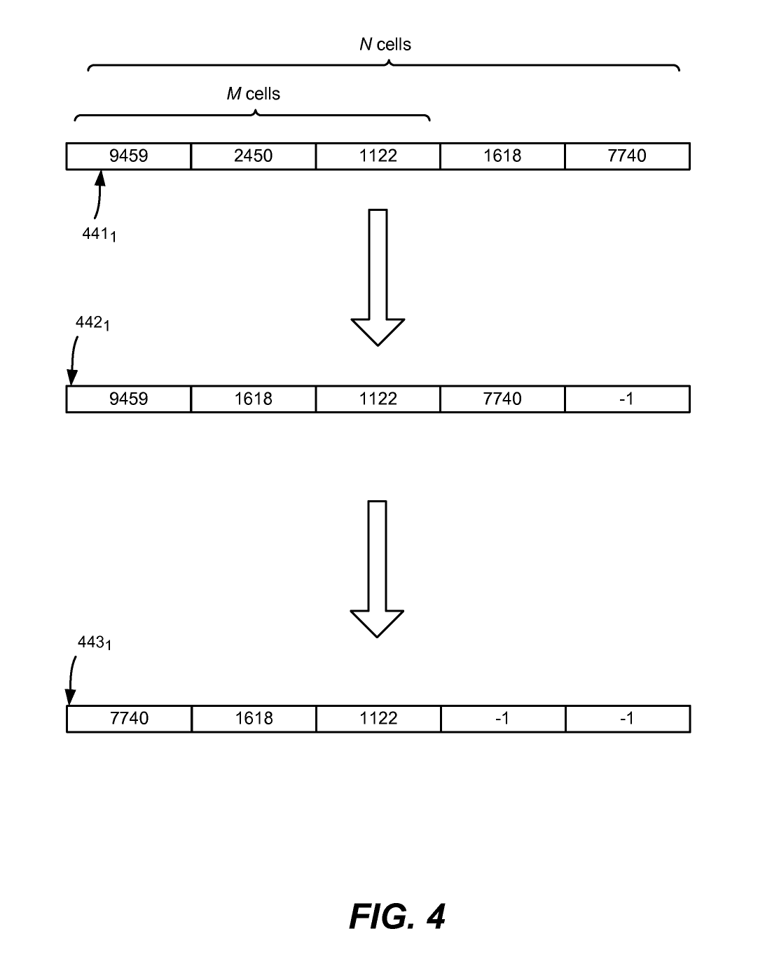

Whenever a node of capacity Cᵢ leaves the consistent hashing table, about L·Cᵢ/Σ{Cᵢ} bins are perturbed. The computational complexity to find a replacement node is L·Cᵢ/Σ{Cᵢ} log(M)·(Σ{Cᵢ}) to reevaluate the Σ{Cᵢ} hash function for each bin that is affected by the leaving node. Described herein is a mechanism for reducing the computational complexity of node leaving by pre-caching a smaller number of additional cells for the consistent hashing table. That is, the assignment function builds an N-cell consistent hashing table by iterating the selection until the Nth cell has been filled, with N greater than M, as generally represented in FIG. 4. As can be readily appreciated M again represents the needed number of nodes for an object, while N may be any appropriate number, with the tradeoff that the larger N, the more memory used, but with less probability of the need to recomputed to find a replacement for a departing node of a bin.

In operation, only the first M cells are used as active cells with respect to mapping. The remaining N minus M cells contain pre-filled entries, which comprise alternate values representing nodes that may be used to efficiently find a replacement node, that is, one that is assigned to replace the node leaving the cluster in any bin assigned to that particular leaving node. In the example of FIG. 4, at a first operational state corresponding to a bin 441₁, nodes 9459, 2450 and 1122 are being used. In a later operational state corresponding to a bin 442₁, the node 2450 has left the cluster, and is thus replaced in this bin's cell by the first alternate, node 1618. Note that any bin that does not have the node 2450 in one of its cells is not changed.

If an alternate is used, that alternate is replaced with the next alternate (appearing as being shifted left FIG. 4, with the shift resulting in an empty slot or being indicated in some other way that cannot be confused with a node, such as minus one (−1)). As can be readily appreciated, the replacement process is similarly applied to any bin in which the leaving node was assigned in a cell thereof, using the alternate pre-computed for each respective bin, efficiently redistributing the workload without needing to re-run the selection computation.

If another node leaves, the process is repeated, e.g., as represented by a third operational state corresponding to bins 443₁, in which the node 9459 in bin 443₁ has left and is replaced by the next alternate, 7740. In this way, only if there is no alternate available for a bin when a node leaves does the assignment function need to be re-run. However, if the number of resources in the cluster is balanced, despite nodes joining and leaving the cluster, there may never be a need to refill the empty slots. In other words, only when enough nodes leave the cluster resulting in an N-M+1 empty cell in at least one bin is there a need to re-populate the cells; even in such a situation, all N-M+1 cells may be repopulated at once, which has a reduced computation complexity.

### Example Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

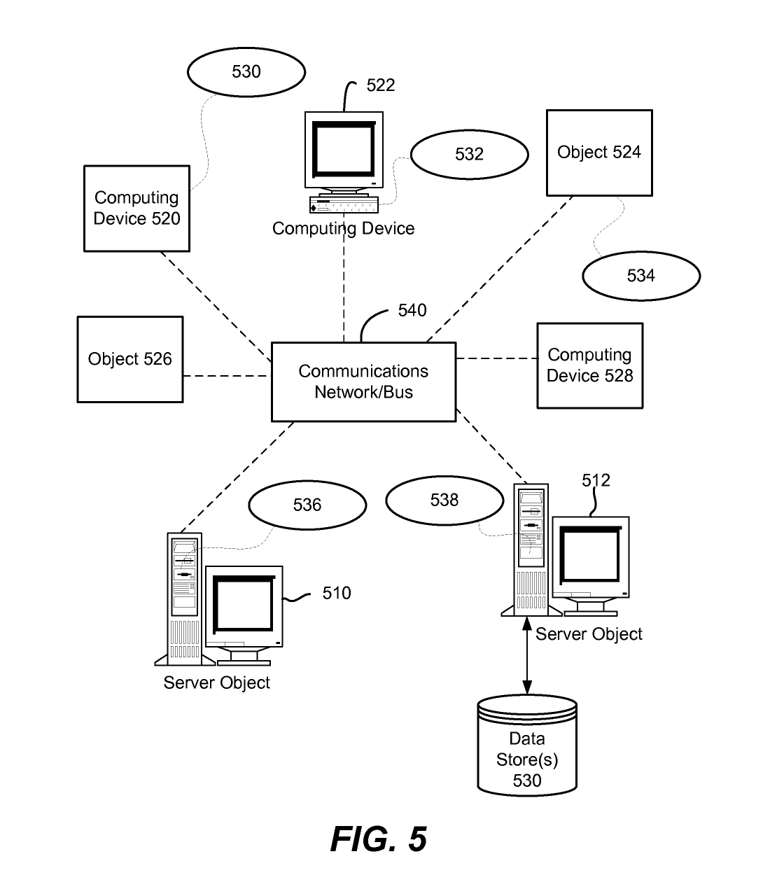

FIG. 5 provides a schematic diagram of an example networked or distributed computing environment. The distributed computing environment comprises computing objects 510, 512, etc., and computing objects or devices 520, 522, 524, 526, 528, etc., which may include programs, methods, data stores, programmable logic, etc. as represented by example applications 530, 532, 534, 536, 538. It can be appreciated that computing objects 510, 512, etc. and computing objects or devices 520, 522, 524, 526, 528, etc. may comprise different devices, such as personal digital assistants (PDAs), audio/video devices, mobile phones, MP3 players, personal computers, laptops, etc.

Each computing object 510, 512, etc. and computing objects or devices 520, 522, 524, 526, 528, etc. can communicate with one or more other computing objects 510, 512, etc. and computing objects or devices 520, 522, 524, 526, 528, etc. by way of the communications network 540, either directly or indirectly. Even though illustrated as a single element in FIG. 5, communications network 540 may comprise other computing objects and computing devices that provide services to the system of FIG. 5, and/or may represent multiple interconnected networks, which are not shown. Each computing object 510, 512, etc. or computing object or device 520, 522, 524, 526, 528, etc. can also contain an application, such as applications 530, 532, 534, 536, 538, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for example communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 5, as a non-limiting example, computing objects or devices 520, 522, 524, 526, 528, etc. can be thought of as clients and computing objects 510, 512, etc. can be thought of as servers where computing objects 510, 512, etc., acting as servers provide data services, such as receiving data from client computing objects or devices 520, 522, 524, 526, 528, etc., storing of data, processing of data, transmitting data to client computing objects or devices 520, 522, 524, 526, 528, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 540 or bus is the Internet, for example, the computing objects 510, 512, etc. can be Web servers with which other computing objects or devices 520, 522, 524, 526, 528, etc. communicate via any of a number of known protocols, such as the hypertext transfer protocol (HTTP). Computing objects 510, 512, etc. acting as servers may also serve as clients, e.g., computing objects or devices 520, 522, 524, 526, 528, etc., as may be characteristic of a distributed computing environment.

### Example Computing Device

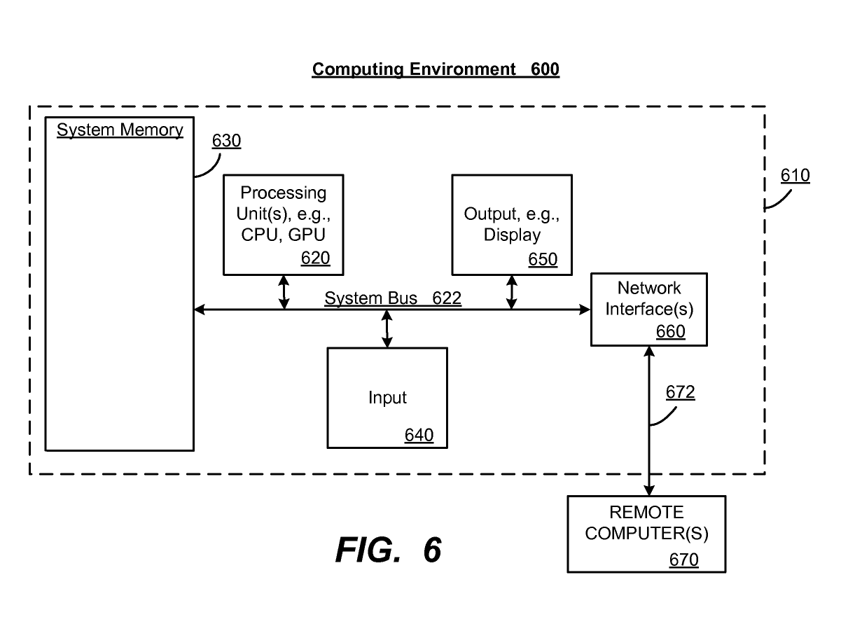

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 6 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 6 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. In addition, the computing system environment 600 is not intended to be interpreted as having any dependency relating to any one or combination of components illustrated in the example computing system environment 600.

With reference to FIG. 6, an example remote device for implementing one or more embodiments includes a general purpose computing device in the form of a computer 610. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640. A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 670. The remote computer 670 may be a personal computer, a server, a router, a network PC, a peer device or other common network node, or any other remote media consumption or transmission device, and may include any or all of the elements described above relative to the computer 610. The logical connections depicted in FIG. 6 include a network 672, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor comprising, assigning node sets to bins of a data structure, each node set corresponding to at least one node of a distributed system, and independent of assigning the node sets, deterministically associating an object with a node set, including mapping the object to one of the bins via a mapping function.

2. The method of claim 1 wherein mapping the object comprises processing an identifier associated with that object using a hash function.

3. The method of claim 1 wherein mapping the object comprises processing an identifier associated with that object using a range function.

4. The method of claim 1 wherein mapping the object comprises processing an identifier associated with that object using a clustering function.

5. The method of claim 1 further comprising, splitting the bin into a plurality of bins.

6. The method of claim 1 wherein assigning the node sets to the bins comprises using a consistent hash function to determine assignment candidates, and using a consistent selection algorithm to select among the assignment candidates.

7. The method of claim 6 wherein using the consistent hash function comprises computing a number of node hash values corresponding to the assignment candidates, in which the number of node hash values is based at least in part upon a capacity value associated with each node.

8. The method of claim 1 further comprising, computing an alternate node set in association with the node set for each bin, the alternate node set corresponding to at least one additional node, and if a node that was in the node set leaves the distributed system, selecting a replacement for the node set by selecting from the alternate node set.

9. The method of claim 1 further comprising, reevaluating node sets for bins when a node joins the distributed system.

10. A system comprising:
a consistent hashing table, the consistent hashing table configured to maintain values representing nodes of a distributed system, in which the consistent hashing table is configured with a plurality of bins, each bin having one or more cells;
an assignment mechanism configured to assign the values to the bins independent of any object identifiers; and
a mapping mechanism configured to deterministically map an object identifier to a mapped bin among the bins to determine a node set comprising the node or nodes that correspond to the value or values of the mapped bin.

11. The system of claim 10 wherein the assignment mechanism comprises a consistent hash function to produce values representative of assignment candidates, and a consistent selection algorithm to select among the values.

12. The system of claim 10 wherein the consistent hash function produces the values based at least in part on capacity data representative of the capacities of the nodes.

13. The system of claim 10 wherein each bin of the consistent hashing table includes an active cell set comprising one or more cells that each contain a value assigned by the assignment mechanism and that are active with respect to mapping, and an alternate cell set comprising one or more cells that each contain a value assigned by the assignment mechanism and that are available for use in determining a replacement value when a node corresponding to a value in the active cell set leaves the distributed system.

14. The system of claim 10 wherein the mapping mechanism comprises a hash function.

15. The method of claim 10 wherein the mapping mechanism comprises a range function.

16. The method of claim 10 wherein the mapping mechanism comprises a clustering function.

17. The method of claim 10 wherein the mapping mechanism maps each object to a separate bin, with the object ID comprising the ID of the bin.

18. The method of claim 10 wherein the distributed system comprises a replicated storage system.

19. One or more computer-readable media having computer-executable instructions, which when executed perform steps, comprising,
in an assignment stage, assigning node values representative of nodes of a distributed system to a data structure configured with bins, including using a consistent hash function to produce a number of one or more hash values for each node based on capacity data associated with each node, selecting node values representative of the nodes from the hash values using a consistent selection algorithm, and assigning selected values to the bins; and
in a mapping stage, mapping an object identifier to a mapped-to bin via a deterministic mapping function, to determine which node or nodes are represented by the mapped-to-bin.

20. The one or more computer-readable media of claim 19 wherein assigning the node values to the bins includes assigning alternate node values.
